(19) United States
(12) Patent Application Publication
(10) Pub. No.: US 2007/0276592 A1
(43) Pub. Date: Nov. 29, 2007

(54) Method for deep mapping

(75) Inventors: Gregory P. Johnson, Tea, SD (US); Kevin M. Brown, Vermillion, SD (US); Brian J. Walton, Vermillion, SD (US)

Correspondence Address: Frank Liebenow, Suite 150, 801 River Road, North Sioux City, SD, 57049, US

(73) Assignee: STATES PRIDE, LLC.

(21) Appl. No.: 11/441,477

(22) Filed: May 26, 2006

(51) Int. Cl. G01C 21/32

(52) U.S. Cl. 701/208; 701/213

(57) ABSTRACT

A method of capturing deep mapping information regarding points of interest includes capturing the location of the point of interest and adding the location to a deep mapping information record, entering specifics regarding the points of interest into the deep mapping information record, marking the deep mapping information record as inactive, verifying the deep mapping information, marking the deep mapping information record as active and then allowing users to search only the active deep mapping information records.

### 1. FIELD OF THE INVENTION

This invention relates to a method for capturing mapping information and more particularly to a method for capturing and verifying mapping information and delivering it to the end user.

### 2. BACKGROUND OF THE INVENTION

Rural America remains quite undiscovered by countless tourists who fly by on the interstate on their way to a handful of heavily advertised tourist attractions. These tourists wind up missing much of the character of their country, the small shops, soda fountains, historic landmarks, bed and breakfast style lodging and natural attractions. Communities across our continents have a story to tell. These stories are worth preserving. The old buildings, the remembrances of past events, the significance of the culturally authentic are important parts of every country's heritage.

Global Positioning Satellite (GPS) mapping systems have been in use for many years and are becoming increasingly present in consumer vehicles such as automobiles and recreational vehicles. These mapping systems assist tourists by providing maps of roads, interstates, cities, lakes, rivers and, perhaps, major attractions such as Mount Rushmore or the Cape May Lighthouse. Systems and methods for creating maps using GPS are known in the art. For example, U.S. Pat. No. 6,236,938 to Atkinson, et al., is hereby incorporated by reference. This patent describes a system and method for creating maps using GPS along with a range finder so that a cartographer can record the location of a distant object (e.g., a mountain peak, island) without traveling to the spot they wish to record. This system would certainly aid in the capture of mapping information and can be used in conjunction with the present invention, but by itself, it does not provide a method whereby detailed information about rural attractions can be captured and mapped.

What is needed is a method for capturing and verifying detailed information about rural attractions such as historic landmarks, small shops, natural attractions and bed and breakfast lodging.

### SUMMARY OF THE INVENTION

Accordingly, an objective of the present invention is to a method whereby a researcher discovers and carefully records data regarding structures such as an old building, an old bridge, a church, a museum, a school and a famous restaurant or places such as a cemetery, a park, an old battlefield and a lake.

Another objective of the present invention is to a method whereby a researcher discovers and carefully records data regarding structures such as an old building, an old bridge, a church, a museum, a school and a famous restaurant or places such as a cemetery, a park, an old battlefield and a lake and a second party verifies the accuracy of such information. The researcher is, for example, a college student and the verifier, for example, is a college professor or city mayor.

In a first embodiment, a computer based system for capturing deep mapping information regarding points of interest is described having a plurality of deep mapping client computers, each deep mapping client computer having: a user interface for controlling operation of the mapping client computer and for accepting information regarding points of interest and adding it to the deep mapping information; a GPS receiver for adding the location of the points of interest to the deep mapping information; a local database for storing the deep mapping information; templates stored in the local database and accessible by the user interface, each template in the plurality of templates related to a particular type of point of interest; and a network interface coupling the mapping client computer to a network for sending the deep mapping information. A deep mapping server system running on a server computer has: a deep mapping database for storing the deep mapping information; a server network interface coupling the server computer to the network; a reception module for receiving the deep mapping information from the deep mapping clients through the network and for storing the deep mapping information in the deep mapping database; and a search engine interfaced to the network through the network interface for providing access to the deep mapping information that is stored in the deep mapping database.

In another embodiment, a computer based server system for capturing deep mapping information regarding points of interest a computer is described including a deep mapping database coupled to the computer for storing deep mapping information and a network interface coupling the computer to a network. A reception module operates on the computer for receiving the deep mapping information from deep mapping clients through the network and stores the deep mapping information in the deep mapping database and a search engine operates on the computer and interfaces to the network through the network interface for providing access to the deep mapping information that is stored in the deep mapping database.

In another embodiment, a computer based client system for capturing deep mapping information regarding points of interest is described including a plurality of computers, each with a processor; a memory; a hard disk; a network interface coupled to a network; a graphics adapter and operatively coupled to a graphics display; a GPS receiver for reading a location of the points of interest; a user interface for controlling operation of the computers and for accepting information regarding the points of interest from a deep mapper; a plurality of local databases operatively stored on the hard drives for storing the deep mapping information; and a plurality of templates stored in the local databases and accessible by the user interfaces, each template in the plurality of templates related to a particular type of the point of interest.

In another embodiment, a method of capturing deep mapping information regarding points of interest is described including capturing the location of the point of interest and adding the location to the deep mapping information; entering specifics regarding the points of interest into the deep mapping information; marking the deep mapping information as inactive; verifying the deep mapping information; marking the deep mapping information as active; and then allowing users to search only the active deep mapping information.

In another embodiment a computer readable medium including computer programming instructions that cause a computer to perform the method for capturing deep mapping information regarding points of interest, the method includes the steps of capturing the location of the point of interest and adding the location to the deep mapping information; entering specifics regarding the points of interest into the deep mapping information; marking the deep mapping information as inactive; verifying the deep mapping information; marking the deep mapping information as active; and allowing users to search only the active deep mapping information.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a schematic view of the system of the present invention.

FIG. 2 illustrates a schematic view of the data capture system of the present invention.

FIGS. 3a and 3b illustrate flow charts of the data capture and verification of the present invention.

FIGS. 4, 4a, 4a1, 4a2 and 4b illustrate data entry templates of the present invention.

FIG. 5 illustrates a typical computer system utilized by the present invention.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures. Reference to a site or point of interest refers to any place or landmark that may be of interest to a visitor such as a tourist. The Deep Mapper (user of the disclosed software, e.g., a researcher) can be anybody: a student, a professor, the mayor or a plain ordinary citizen. Anybody with some special knowledge of a specific place, structure or natural setting can make a good “Deep Mapper.” The verifier can be anybody in a position to verify the information captured by the researcher such as a professor, teacher, mayor, law enforcement officer, etc. This hierarchy of researcher coupled with one or more verifiers produces more reliable data, in that, the researcher's data is checked by a verifier to make sure it is accurate and does not include any offensive material.

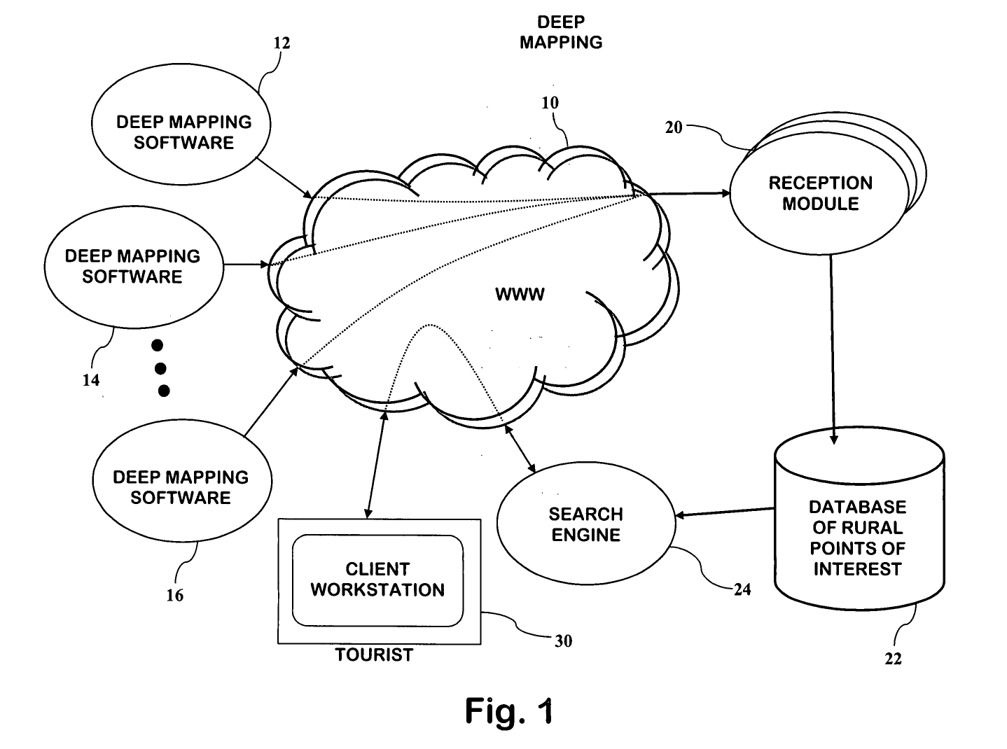

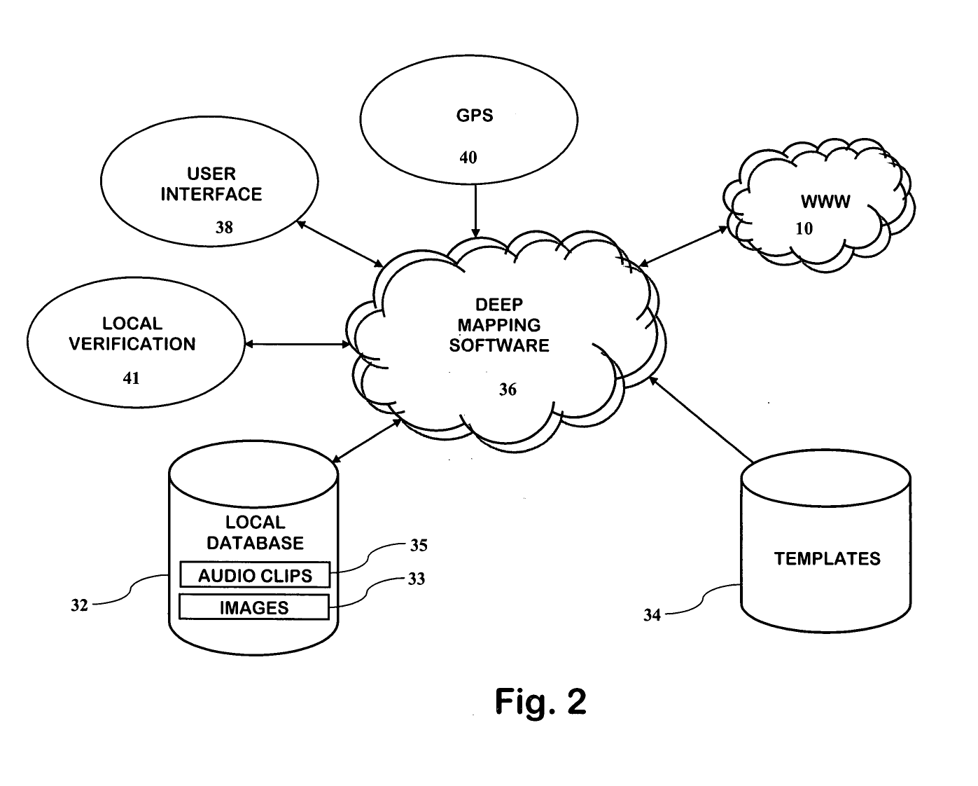

Referring to FIG. 1, a schematic view of the system of the present invention is shown. The components of the Deep Mapping system are connected by a network 10, in this embodiment, by the World Wide Web 10 (e.g. the Internet). A plurality of capture agents 12/14/16 running deep mapping software 36 (see FIG. 2) are coupled to a reception module 20 through the network 10. As will be explained, the capture agents 12/14/16 capture data regarding a place of interest such as an old church, a restaurant, etc. The captured data includes GPS coordinates, a picture and a description. Once the captured data is complete, it is verified either by local verification 41 or verification at the reception module 20. Verification checks the data for accuracy, grammar, spelling and the like, and then when acceptable, enters the data into a record within a database of rural points of interest 22. These records are then searchable by tourists at a client workstation 30 through the network 10 and a search engine 24. For example, the tourist can search for old churches near Mount Rushmore and obtain a list of old churches in that location along with exact locations of each, a description of each and, optionally, one or more pictures of each.

Referring to FIG. 2, a schematic view of the data capture system of the present invention is shown. The Deep Mapping software 36 has a user interface 38 for displaying data records, prompting the deep mapping user and for capturing data from the deep mapping user. A GPS system 40 interfaces with the deep mapping software 36 to provide accurate coordinates of the point of interest being mapped. The deep mapping software 36 accesses a plurality of templates 34 designed to describe different types of points of interest. For example, there can be a template for a structure, natural sites, bodies of water, etc. Each template has different fields regarding the different types of objects. For example, a building or structure template can have a field for number of rooms but that field would not be relevant to a stream or lake.

Information is stored in a local database 32 that can be a simple file system or a database managed by a database manager as known in the industry. The data stored in the database includes data captured from the user interface 38 as well as images of the points of interest 33 and audio clips 35 obtained at the points of interest. In some embodiments, there is a local verification module 41 which is configured to allow verification of the captured data before it is forwarded to the reception module 20. In these embodiments, it is envisioned that the researcher is, for example, a student, and the captured data is verified by, for example, a professor or teacher, before it is transmitted to the reception module 20. In some embodiments, the captured data is locked within the local computer until the verifier logs onto the local computer and verifies (approves) the data, at which time it is marked as approved and can be sent to the reception module 20 at any time thereafter.

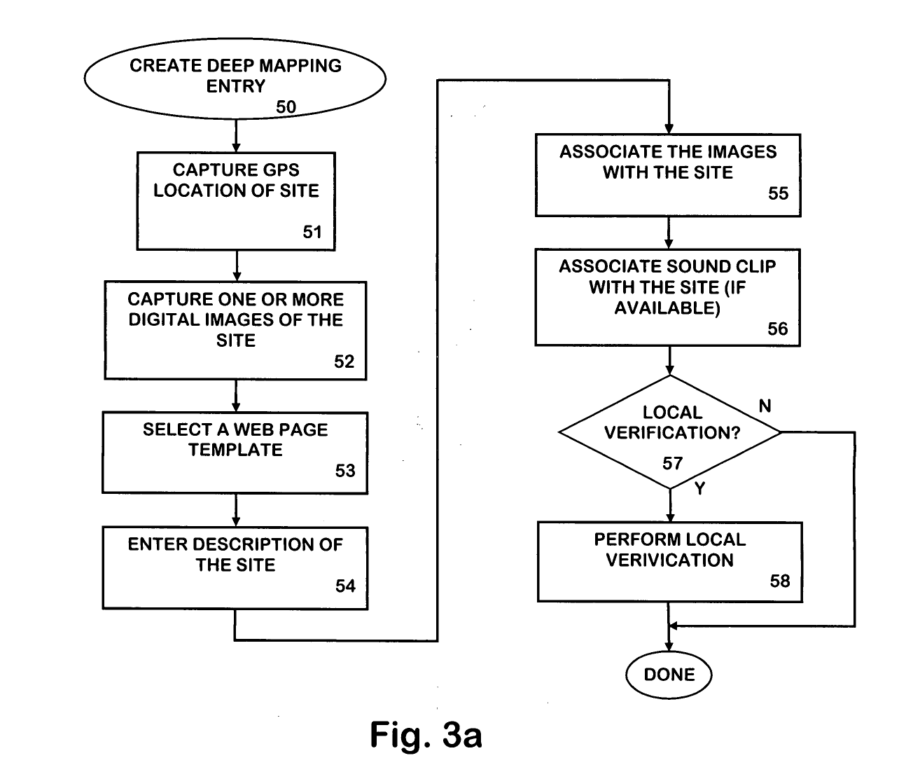

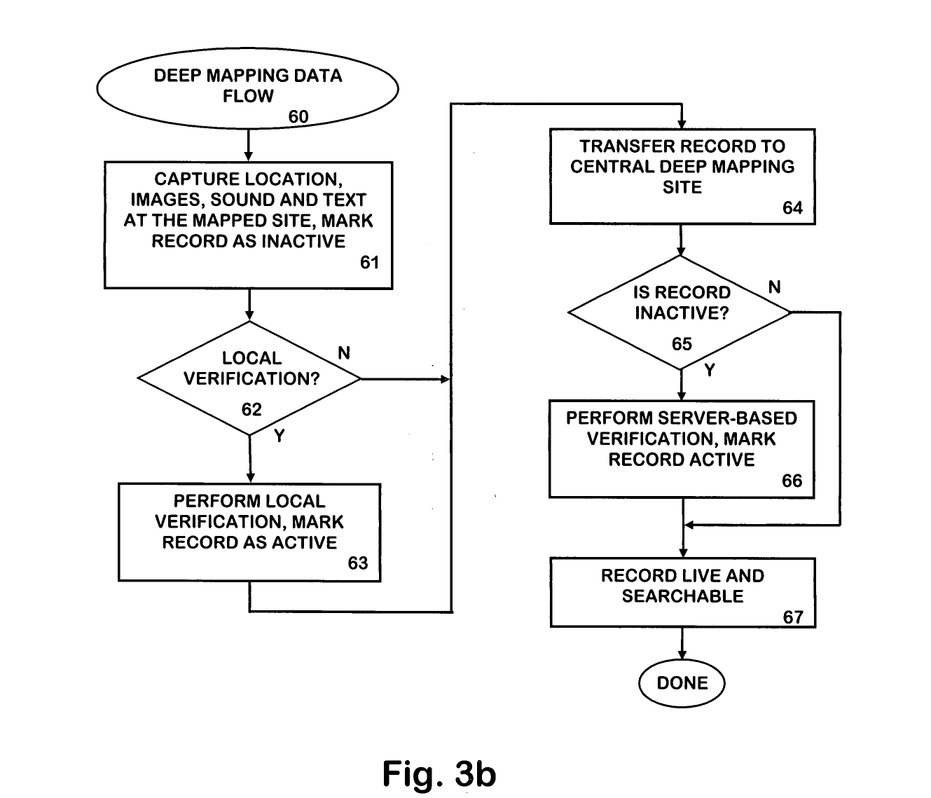

Referring to FIG. 3a, a flow chart of the data capture of the present invention is shown. Although the order of this process is not important, in this example, the process for creating a deep mapping entry 50 starts by capturing the location of the site 51 by using the GPS hardware of the capturing computer system. The GPS hardware, which is well known in the industry, uses a series of satellites that are in geo-synchronous orbit around the earth to determine a precise location of the point of interest by positioning the computer system that contains the GPS hardware at the point of interest and extracting the coordinate information from the GPS hardware (as known in the industry). Next, one or more digital images (still or motion) are captured 52. Next, a web page template is selected 53. Various different web page templates are pre-designed for use by the deep mapping user. Each template has information fields pertaining to the specific type of point of interest. For example, for a structure, there may be a field for approximate date of construction while for a body of water; there may be a field for maximum depth and average summer temperature, etc.

Next, the Deep Mapper (researcher) enters a description of the location in the format of the template 54. If there are any digital images or video clips of the point of interest, they are associated with the site 55 and, likewise, if there are any audio clips, they are also associated with the site 56. If local verification is required 57, local verification is performed at the local computer or local network 58 before the completed record along with images, sound and GPS coordinates is sent to the central deep mapping server.

Referring to FIG. 3b, a flow chart of the data flow of the present invention is shown 60. Data regarding the site is captured along with location, sound and images as in FIG. 3a 61. At this point, the data is marked as inactive meaning that, even if it is transferred to the server database 22, it is not “live” and, therefore, cannot be accessed through the search engine 24. Also, as in FIG. 3a, if local verification is required 62, local verification is performed 63 and, when complete, the data is marked as active (e.g., searchable). Local verification can be performed by a verifier logging onto the researcher's computer (e.g., with a user name and password), reviewing the data, optionally editing the data and, if satisfied, approving the data at which time the data is marked as active. The verifier is, by example, a teacher, professor or mayor. Next, the data is transferred to the central deep mapping site 64 and is received by the reception module 20. The data is either active (if local verification was performed) or inactive (if server-based verification is needed). It is well know how to transfer data from the local computer to the deep mapping server, including transmission by data connection (e.g., internet or dial-up) and copying the record to a recordable media and physically transferring the recordable media to the deep mapping server where it is read into the deep mapping server.

Once the record is at the deep mapping server, it is stored in the database of points of interest 22. In the preferred embodiment, if it is already marked active 65, then it is immediately searchable 67 by, for example, tourists. If it is currently marked inactive 65, then it must be verified before it can be searched. Therefore, it is present in the database 22, but not searchable. In this embodiment, the verifier (e.g., a professor or teacher) logs onto the deep mapping server using a user name and password, accesses the record and reviews the data, optionally edits the data and, if satisfied, approves the data at which time the data is marked as active and is immediately searchable 67. Alternately, in some embodiments, server verification is also performed on the record before it is set to active in the database of points of interest 22.

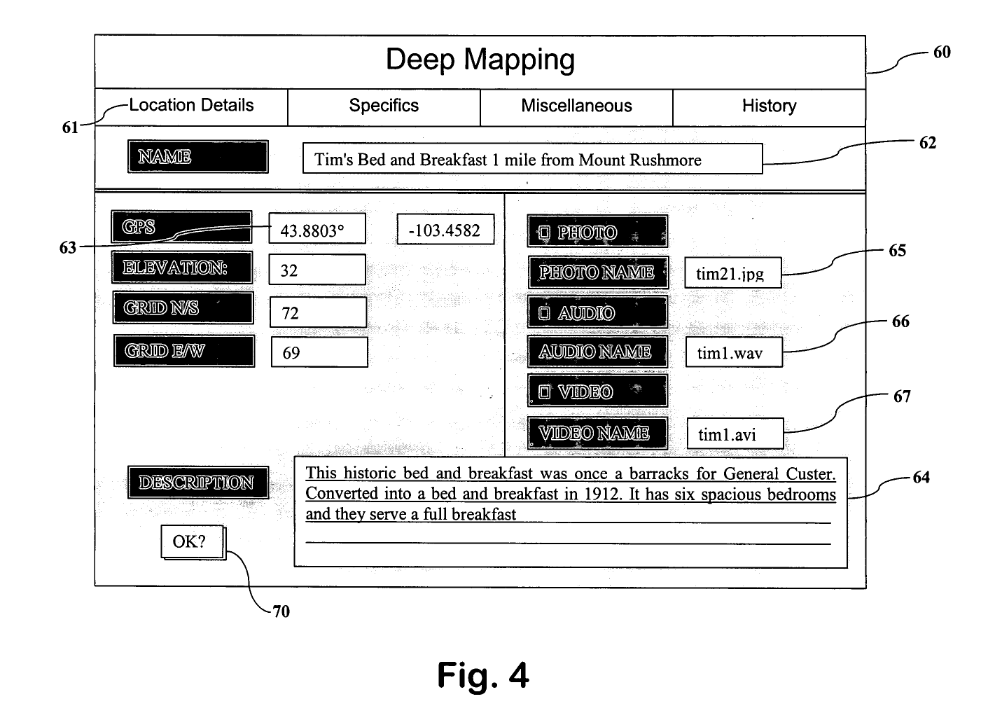

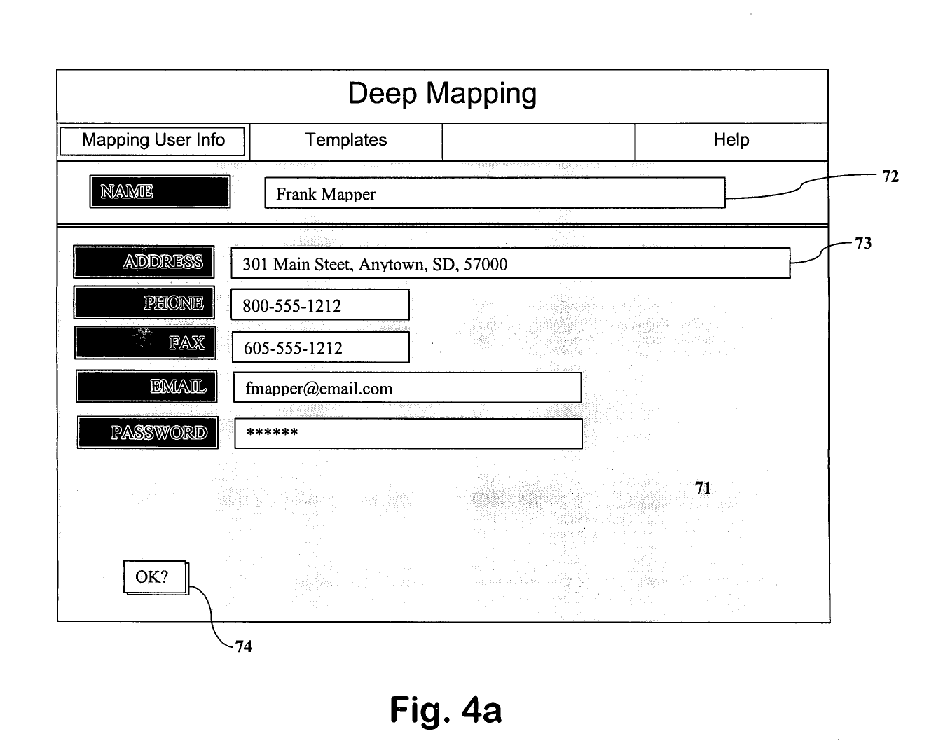

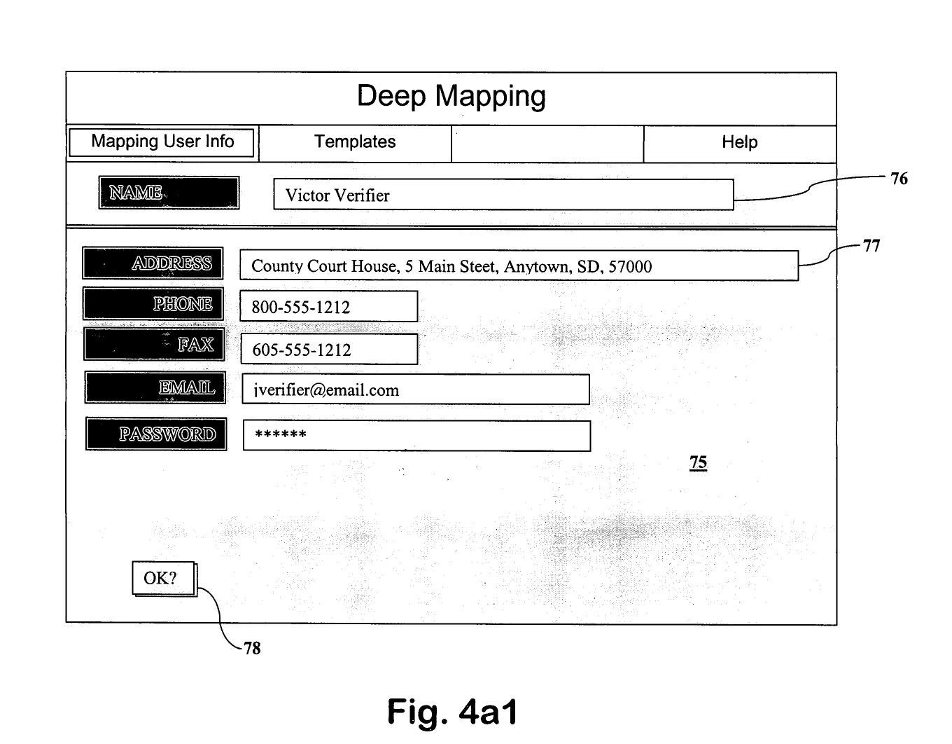

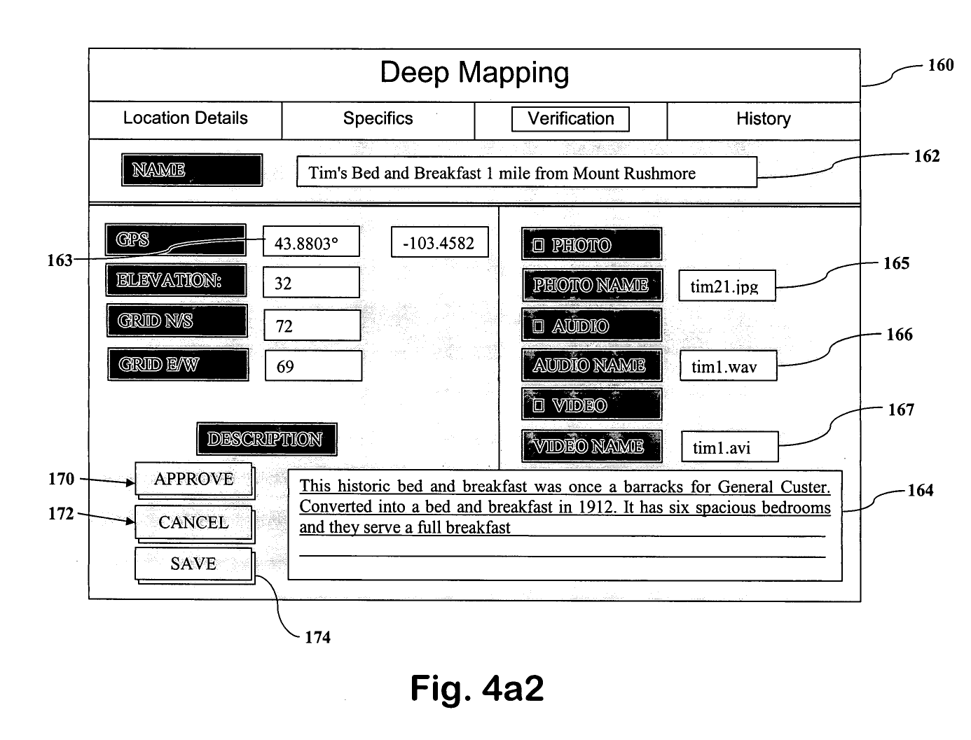

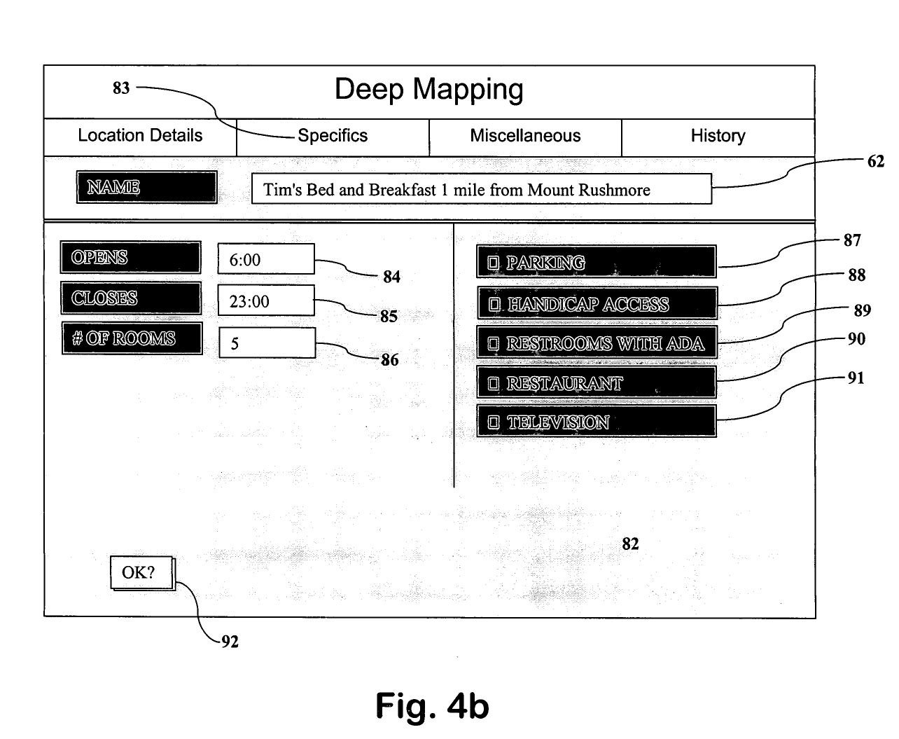

Referring to FIG. 4, a data entry template of the present invention is shown. This exemplary template is for a structure 60 such as a building, bridge, church, etc. Other data entry screens are possible based upon the various templates described previously. The deep mapping user has selected to enter location information 61. The location coordinates 63 have been imported from the GPS hardware or alternately, can be entered manually. A general name for the structure 62 is entered by the deep mapping software user. A description 64 is entered by the user of the deep mapping software. In this example, this field is limited to 500 words to keep it as brief as possible, though any limit may be applied. If there are still digital images, video clips or audio clips, the file location of the still digital image is entered into the photo name field 65, the file location of the audio clip is entered into the audio name field 66 and the file location of the video clip is entered into the video name field 67. Any number of image and audio fields is possible. Furthermore, in some embodiments, the image or audio file location is set using a browse function as known in the art. Once all data is entered, the OK button 70 is activated. In some embodiments, the OK button 70 simply saves the record to the local database 32. In other embodiments, it saves the record to the local database 32 and either sends it to the reception module 20 (if online) or queues it to be sent to the reception module 20 (if offline) the next time the deep mapping software is connected to the network 10. In some embodiments, the deep mapping software user is assigned a user name and password, thereby authorizing access to the deep mapping system and permitting the upload of deep mapping data through the deep mapping software.

Referring to FIG. 4a, a user data entry screen 71 of the present invention is shown. In this exemplary screen, information regarding the Deep Mapper or researcher is captured and associated with one or more sets of deep mapping data. The user's name 72, address 73, phone number and other contact information is captured so that if there is any question regarding the data that they have captured arises when it reaches the server system, the researcher can be contacted to resolve any issues with the data. Once this information is captured, the user initiates the OK function 74 to save it in the local database 32. Information from this screen is later associated with each set of deep mapping software captured by that user.

Referring to FIG. 4a1, a user data entry screen 75 of the present invention is shown. In this exemplary screen, information regarding the deep mapping verifier is captured. The user's name 76, address 77, phone number and other contact information is captured so that if there is any question regarding the data that they have captured arises when it reaches the server system, they can be contacted to resolve any issues with the data. Once this information is captured, the user initiates the OK function 78 to save it in the local database 32 or deep mapping database 22. The information includes a password required to log onto either a local computer or the deep mapping server for approving records captured by the Deep Mapper.

Referring to FIG. 4a2, a data verification screen 160 of the present invention is shown. This exemplary data verification screen 160 is based upon a template a structure such as a building, bridge, church, etc. Other verification screens are possible relating to the various data entry templates previously described. The deep mapper had previously entered information. The location coordinates 163 had been imported from the GPS hardware or alternately, were entered manually. A general name for the structure 162 was entered by the deep mapper. A description 164 was entered by the deep mapper. Any still digital images, video clips or audio clips were captured and the file location of the still digital image is in the photo name field 165, the file location of the audio clip is in the audio name field 166 and the file location of the video clip is in the video name field 167. The verifier can update the data by typing over it or other methods known in the industry. Once the verifier is satisfied with all of the data, the “approve” button 170 is activated, thereby marking the data record as active and making it searchable. If the verifier does not want to approve the record, he or she activates the cancel button 172, leaving it in the inactive state until the verifier is ready to approve. If the verifier makes some changes, but is still not ready to verify the record, they select the save function 174, which saves the record in the inactive state along with any changes made by the verifier.

Referring to FIG. 4b, a user data entry screen 82 of the present invention is shown. In this exemplary screen, information regarding the building shown in FIG. 4 is further described. This screen lets the deep mapping user enter further details, e.g., specifics 83, regarding the same location as in FIG. 4; therefore, the name of the location 62 is the same as in FIG. 4. The content of this screen varies based upon the type of place being documented. In this instance, an establishment is being documented (e.g., a bed and breakfast) and specifics are entered regarding the opening time 84, the closing time 85, the number of rooms (e.g., bedrooms) 86, whether parking is available 87, handicap access available 88, restrooms with ADA compliance 89, a co-located restaurant 90 and in-room television 91. Once all data is entered, the deep mapping user selects the OK button 92 and the information is saved.

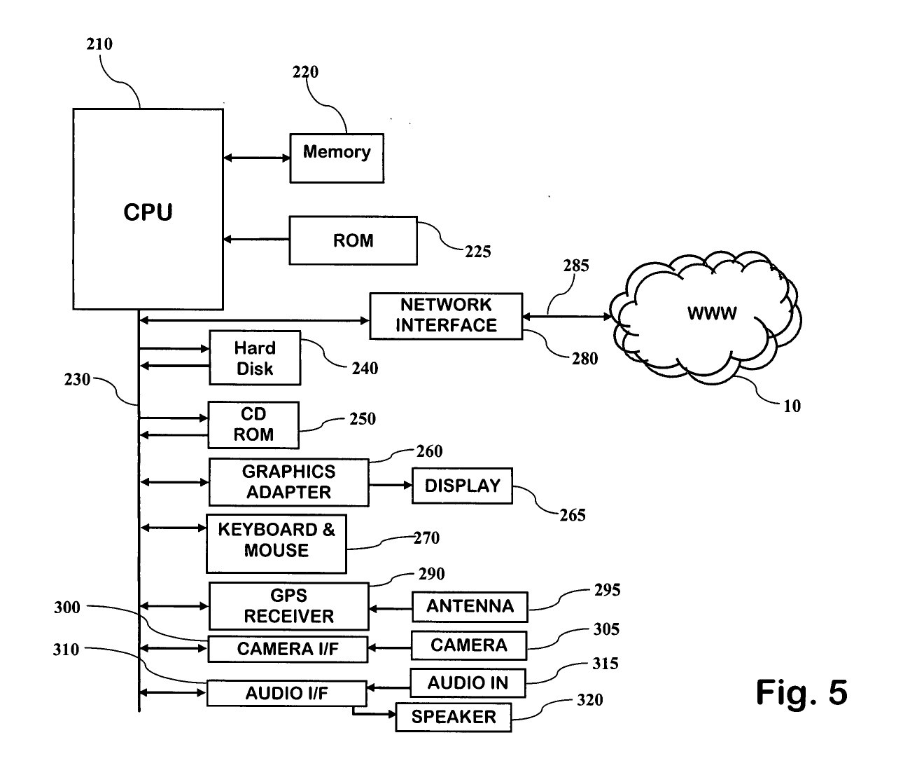

Referring to FIG. 5, a typical computer system utilized by the present invention is shown. Although shown in its simplest form, having a single processor, many different computer architectures are known that accomplish similar results in a similar fashion and the present invention is not limited in any way to any particular computer system. The present invention works well utilizing a single processor system as shown in FIG. 5, a multiple processor system where multiple processors share resources such as memory and storage, a multiple server system (not shown) where several independent servers operate in parallel or any combination. The processing system described or a similar system can be used to run the deep mapping software as well as the server based software including the deep mapping database 22 and search engine.

In this exemplary embodiment, a processor 210 is provided to execute stored programs that are generally stored for execution within a memory 220. The processor 210 can be any processor or a group of processors, for example an Intel Pentium-4® CPU or the like. The memory 220 is connected to the processor and can be any memory suitable for connection with the selected processor 210, such as SRAM, DRAM, SDRAM, RDRAM, DDR, DDR-2, etc. Firmware is stored in firmware storage 225 that is connected to the processor 210 and may include initialization software known as BIOS. This initialization software usually operates when power is applied to the system or when the system is reset. In some embodiments, the software is read and executed directly from the firmware storage 225. Alternately, the initialization software is copied into the memory 220 and executed from the memory 220 to improve performance.

Also connected to the processor 210 is a system bus 230 for connecting to peripheral subsystems such as a network interface 280, a hard disk 240, a CDROM 250, a graphics adapter 260, a keyboard/mouse 270, Global Positioning System Receiver 290, camera interface 300 and audio interface 310. The graphics adapter 260 receives commands and display information from the system bus 230 and generates a display image that is displayed on the display 265.

In general, the hard disk 240 may be used to store programs, executable code and data persistently, while the CDROM 250 may be used to load said programs, executable code and data from removable media onto the hard disk 240. These peripherals are meant to be examples of input/output devices, persistent storage and removable media storage. Other examples of persistent storage include core memory, FRAM, flash memory, etc. Other examples of removable media storage include CDRW, DVD, DVD writeable, compact flash, other removable flash media, floppy disk, ZIP®, laser disk, etc. In some embodiments, other devices are connected to the system through the system bus 230 or with other input-output connections. Examples of these devices include printers; mice; graphics tablets; joysticks; and communications adapters such as modems and Ethernet adapters.

The network interface 280 connects the computer-based system to the world-wide-web 10 through a link 285 that is, preferably, a high speed link such as a cable broadband connection, a Digital Subscriber Loop (DSL) broadband connection, a T1 line or a T3 line.

The GPS receiver 290 is interfaced with a GPS antenna 295 to receive GPS signals from the array of GPS satellites positioned around the world. The camera interface 300 is optionally connected to a camera 305 for importing digital images and video clips from a digital camera 305. The audio interface 310 has an audio input 315 that can be connected to a microphone or other audio source and, optionally, a speaker 320 or earphone (not shown) for listening to stored audio clips.

Equivalent elements can be substituted for the ones set forth above such that they perform in substantially same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A computer based system for capturing deep mapping information regarding points of interest, the computer based system comprising:
a plurality of deep mapping client computers, each deep mapping client computer comprising:
a plurality of local databases, each operatively coupled to one of the deep mapping client computers for storing the deep mapping information;
a user interface operating on each of the deep mapping client computers for controlling operation of the deep mapping client computers and for accepting information regarding points of interest and adding the information regarding points of interest to the deep mapping information in the local database;
a GPS receiver operatively coupled to the mapping client computer for adding the location of the points of interest to the deep mapping information;
a plurality of templates stored in the local database and accessible by the user interface, each template in the plurality of templates related to a particular type of point of interest;
a network interface coupling the deep mapping client computer to a network for sending the deep mapping information;
a deep mapping server system running on a server computer, the deep mapping server system comprising:
a deep mapping database operatively coupled to the server computer for storing the deep mapping information;
a server network interface coupling the server computer to the network;
a reception module operating on the server computer for receiving the deep mapping information from the deep mapping client computers through the network and for storing the deep mapping information in the deep mapping database; and
a search engine interfaced to the network through the network interface for providing access to the deep mapping information that is stored in the deep mapping database.

2. The computer based system for capturing deep mapping information of claim 1, wherein the deep mapping information includes digital images.

3. The computer based system for capturing deep mapping information of claim 1, wherein the deep mapping information includes digital video clips.

4. The computer based system for capturing deep mapping information of claim 1, wherein the deep mapping information includes audio clips.

5. The computer based system for capturing deep mapping information of claim 1, the plurality of deep mapping client computers further comprising a verification module operating on each of the deep mapping client computers for verifying the deep mapping information.

6. The computer based system for capturing deep mapping information of claim 1, the deep mapping server system further comprising a server-based verification module operating on the server computer for verifying the deep mapping information.

7. A computer based server system for capturing deep mapping information regarding points of interest, the system comprising:
a computer;
a deep mapping database operatively coupled to the computer for storing the deep mapping information;
a network interface operatively coupling the computer to a network;
a reception module operating on the computer for receiving the deep mapping information from a plurality of deep mapping client computers through the network and for storing the deep mapping information in the deep mapping database; and
a search engine operating on the computer and interfaced to the network through the network interface for providing access to the deep mapping information that is stored in the deep mapping database.

8. The computer based server system for capturing deep mapping information regarding points of interest of claim 7, further comprising a server-based verification module operating on the computer for verifying the deep mapping information.

9. A computer based client system for capturing deep mapping information regarding points of interest, the system comprising:
a plurality of computers, each computer comprising:
a processor;
a memory operatively coupled to the processor;
a hard disk operatively coupled to the processor;
a network interface operatively coupled to the processor and operatively coupled to a network;
a graphics adapter operatively coupled to the processor and operatively coupled to a graphics display;
a GPS receiver operatively coupled to the processor for reading a location of the points of interest;
a user interface operating on each of the plurality of computers for controlling operation of the computers and for accepting information regarding the points of interest from a deep mapper;
a plurality of local databases, each local database operatively coupled to one of the computers; and
a plurality of templates stored in the local databases and accessible by the user interfaces, each template in the plurality of templates related to a particular type of the point of interest.

10. The computer based client system for capturing deep mapping information regarding points of interest of claim 9, further comprising a verification module operating on each of the plurality of computers providing a verification user interface allowing a verifier to verify the deep mapping information before the information is made searchable.

11. A method of capturing deep mapping information regarding points of interest, the method comprising:
capturing a location of the point of interest and adding the location to the deep mapping information;
entering specifics regarding the points of interest into the deep mapping information;
marking the deep mapping information as inactive;
verifying the deep mapping information;
marking the deep mapping information as active; and
allowing users to search only the active deep mapping information.

12. The method of capturing information regarding points of interest of claim 11, whereas the capturing of the location is performed by a GPS receiver.

13. The method of capturing information regarding points of interest of claim 11, whereas the verifying is performed at a server.

14. The method of capturing information regarding points of interest of claim 11, whereas entering specifics further comprises associating images with the deep mapping information.

15. A computer readable medium including computer programming instructions that cause a computer to perform the method for capturing deep mapping information regarding points of interest, the method comprising the steps of:
capturing a location of the point of interest and adding the location to the deep mapping information;
entering specifics regarding the points of interest into the deep mapping information;
marking the deep mapping information as inactive;
verifying the deep mapping information;
marking the deep mapping information as active; and
allowing users to search only the active deep mapping information.

16. The method of capturing deep mapping information regarding points of interest of claim 15, whereas the capturing of the location is performed by a GPS receiver.

17. The method of capturing deep mapping information regarding points of interest of claim 15, whereas the verifying is performed at a server.

18. The method of capturing deep mapping information regarding points of interest of claim 15, whereas entering specifics further comprises associating images with the deep mapping information.
